(19) United States
(12) Patent Application Publication
(10) Pub. No.: US 2015/0003638 A1
(43) Pub. Date: Jan. 1, 2015

(54) SENSOR DEVICE

(71) Applicant: OMRON Corporation, Kyoto-Shi, Kyoto (JP)

(72) Inventor: Takashi Kasai, Kyoto (JP)

(73) Assignee: OMRON CORPORATION, Kyoto-Shi, Kyoto (JP)

(21) Appl. No.: 14/377,707

(22) PCT Filed: Feb. 26, 2013
(86) PCT No.: PCT/JP2013/054950

§ 371 Date: Aug. 8, 2014

(30) Foreign Application Priority Data
Feb. 29, 2012 (JP) 2012-043381

(51) Int. Cl. H04R 1/08

(52) U.S. Cl. CPC H04R 1/08
USPC 381/122

(57) ABSTRACT

A microphone has a package, a support base fixed to an inner surface of the package, and a plurality of acoustic sensors disposed on a surface of the support base. The package has a sound hole opened in a region in which the support base is disposed. The support base has penetration holes that include a plurality of openings opened in the surface of the support base and that have the sound hole and a cavity in each of the acoustic sensors in communication with each other. The openings of the penetration holes in the surface of the support base are spaced apart from each other, and are in communication with the cavity of each of the different acoustic sensors.

### BACKGROUND

1. Technical Field

The present invention relates to a microphone having a plurality of built-in acoustic sensors.

2. Related Art

FIG. 1A is a schematic cross-sectional view illustrating a structure of a general microphone. In this microphone 11, an acoustic sensor 13 (sensor chip) and a processing circuit 14 are mounted on a bottom surface of a package 12. The acoustic sensor 13 and the processing circuit 14 are connected by a bonding wire 15, and the processing circuit 14 is connected to a circuit pattern in the package 12 by a bonding wire 16. Further, a sound hole 17 is opened in an upper surface of the package 12.

In the microphone 11 adopting the structure illustrated in FIG. 1A, acoustic vibration is introduced from the sound hole 17 into the package 12 (a direction in which the acoustic vibration is transmitted is indicated by an arrow in FIG. 1A. The same applies to the following drawings). This acoustic vibration enters the acoustic sensor 13 from acoustic holes 18 opened in the upper surface of the acoustic sensor 13, and vibrates a diaphragm 19. The vibration of the diaphragm 19 in this case converts the acoustic vibration into a change of a capacitance between the diaphragm 19 and a fixed electrode film 20.

It is known that a volume of a space on a side opposite to a side to which the acoustic vibration is transmitted based on a back chamber 21, i.e., the diaphragm 19 needs to be increased to improve the sensitivity of the capacitance type microphone 11 and acoustic characteristics such as frequency characteristics.

However, in the microphone 11 adopting the structure illustrated in FIG. 1A, an internal space of the acoustic sensor 13 is a back chamber, and therefore the volume of the back chamber is limited and cannot be increased so much.

Hence, a method of directly connecting the sound hole 17 of the package 12 to the acoustic sensor 13 as illustrated in FIG. 1B is proposed as a method of actually improving the sensitivity of the microphone and acoustic characteristics such as frequency characteristics. A microphone 22 illustrated in FIG. 1B is provided with the sound hole 17 at a position directly connected with the internal space of the acoustic sensor 13. According to such a mode, the acoustic vibration introduced from the sound hole 17 directly enters the acoustic sensor 13, and then the internal space of the acoustic sensor 13 is a front chamber 23 and a space in the package 12 (an external space of the acoustic sensor 13) is a back chamber 21. Consequently, it is possible to increase the volume of the back chamber 21 without being restricted by the size of the acoustic sensor 13, and improve the acoustic characteristics.

Further, there is a method of building two acoustic sensors in a microphone as another method of improving a sensitivity of a microphone and acoustic characteristics such as frequency characteristics. When two sensor chips are built in one package, it is possible to improve the sensitivity of the microphone by adding outputs of the two acoustic sensors, cancel noise and, as a result, improve a signal to noise ratio (S/N ratio). Further, when two acoustic sensors of different sensitivities, sound pressure bands and frequency bands are built in, it is possible to obtain characteristics which cannot be achieved by one acoustic sensor by using the outputs of these acoustic sensors in combination while switching the outputs by a subsequent circuit. By, for example, using an acoustic sensor having a high sensitivity and supporting a low sound pressure and an acoustic sensor having a low sensitivity and supporting a high sound pressure, and switching between the acoustic sensors according to a sound pressure band, it is possible to realize a pseudo microphone having a high sensitivity and supporting a high sound pressure.

A microphone having a plurality of built-in acoustic sensors is disclosed in, for example, Patent Documents 1 and 2. However, in the microphones disclosed in Patent Documents 1 and 2, the two acoustic sensors are arranged in a bottom surface of a package and a sound hole is opened in an upper surface of the package, and therefore the sound hole of the package cannot be directly connected to the acoustic sensors.

Further, in the microphones disclosed in Patent Documents 1 and 2, the two acoustic sensors are provided on one substrate and are integrated. There is a concern that, when the two acoustic sensors are integrated, vibration of a diaphragm of one acoustic sensor is transmitted to the other acoustic sensor through the substrate, and the acoustic sensors interfere with each other and cause noise. Further, in case where the two acoustic sensors are provided on one substrate, only when the two acoustic sensors both normally function, the acoustic sensors can be used, and therefore there may be a decrease in a yield rate compared to an independent acoustic sensor. Therefore, even when two acoustic sensors are built in a microphone, separate acoustic sensors are preferably used instead of integrated acoustic sensors.

In a microphone 31 illustrated in FIG. 2A, two independent acoustic sensors 13a and 13b are mounted on a bottom surface of the package 12, and one sound hole 17 opened in the bottom surface of the package 12 is directly connected to an internal space of each of acoustic sensors 13a and 13b. FIG. 2B illustrates an inside of the package 12 of this microphone 31. In the microphone 31, part of acoustic vibration introduced from the sound hole 17 of the package 12 enters the acoustic sensor 13a and is detected, and the other part of the acoustic vibration enters the acoustic sensor 13b and is detected. Further, the internal spaces of the acoustic sensors 13a and 13b are the front chambers 23 and a space in the package 12 is the back chamber 21, so that it is possible to increase the volume of the back chamber 21.

However, this structure also has a concern that, when the two acoustic sensors 13a and 13b are arranged in contact with each other, vibration of one acoustic sensor is transmitted to the other acoustic sensor, the acoustic sensors interfere with each other and cause noise and therefore performance lowers. Further, when each of the acoustic sensor is attached to a substrate by a general assembly device such as a die bond device, acoustic sensors are sequentially attached one by one, and therefore a gap between the acoustic sensors cannot be removed and the acoustic sensors 13a and 13b cannot be arranged in contact with each other. Therefore, as illustrated in FIG. 2A, part of acoustic vibration having entered the sound hole 17 of the package 12 passes through a gap between the acoustic sensor 13a and the acoustic sensor 13b and leaks to the back chamber 21. The acoustic vibration having leaked to the back chamber 21 reaches the upper surface of the diaphragm through acoustic holes of each of the acoustic sensors 13a and 13b, and therefore acoustic characteristics such as low frequency characteristics of a microphone may eventually deteriorate.

Further, in a microphone 32 illustrated in FIG. 3A, the two independent acoustic sensors 13a and 13b are mounted on the bottom surface of the package 12, and the two sound holes 17 and 17 opened in the bottom surface of the package 12 are directly connected to the internal spaces of the acoustic sensors 13a and 13b, respectively. FIG. 3B illustrates an inside of the package 12 of this microphone 32. This microphone 32 does not have a concern that acoustic vibration leaks from between the acoustic sensors 13a and 13b to the back chamber 21. However, the two acoustic sensors 13a and 13b need to be assembled to meet each of the sound holes 17 and 17, and therefore it is difficult to assemble and handle the acoustic sensors 13a and 13b. Further, when there is a difference between acoustic vibrations entering the two sound holes 17 and 17, there is a concern that an interference occurs when a processing circuit adds outputs of both of the acoustic sensors 13a and 13b.
Patent Document 1: US Patent Publication No. 2007-47746 Specification
Patent Document 2: US Patent Publication No. 2010-183167 Specification

### SUMMARY

One or more embodiments of the present invention provides a microphone which can make compatible both of (1) that a sound hole of a package is directly connected to an acoustic sensor and (2) that a plurality of acoustic sensors is built in the package, which is effective measure to improve acoustic characteristics of the microphone.

A microphone according to one or more embodiments of the present invention has: a package; a support base fixed to an inner surface of the package; and a plurality of acoustic sensors disposed on a surface of the support base, and the package includes a sound hole opened in a region in which the support base is disposed, the support base includes penetration holes configured to include a plurality of openings opened in the surface of the support base and have the sound hole and a cavity in each of the acoustic sensors in communication, and the openings of the penetration holes in the surface of the support base are spaced apart from each other, and are in communication with the cavity of each of the different acoustic sensors. In this regard, a plurality of openings of the penetration holes opened in the surface of the support substrate may be respective openings opened in the upper surfaces of a plurality of penetration holes or may be a plurality of openings opened in the upper surface of one penetration hole.

In the microphone of one or more embodiments of the present invention, the sound hole of the package is communication with the cavity of each acoustic sensor through the penetration hole of the support base. Consequently, it is possible to directly connect the sound hole to each acoustic sensor. Consequently, the cavity in the acoustic sensor is a front chamber and a space outside the acoustic sensor in the package is a back chamber (exhaust chamber), so that it is possible to increase a volume of the back chamber. As a result, it is possible to improve the sensitivity of the microphone and acoustic characteristics such as frequency characteristics. Further, a plurality of acoustic sensors is built in, so that it is possible to improve the sensitivity of the microphone by synthesizing outputs of the acoustic sensors or widen a sound pressure band or a frequency band by switching between outputs. Furthermore, by mounting the acoustic sensors on the support base and then accommodating the acoustic sensors and the support base in the package, an operation of assembling the microphone becomes easy. Still further, it is possible to enhance the strength of the package by adhering the interposer to the package.

In a microphone according to one or more embodiments of the present invention, the support base includes a plurality of independent penetration holes, and at least part of openings of the penetration holes on a side of the sound hole overlap an opening of the sound hole on a side of the support base. Accordingly, it is possible to simplify the shape of the support base and reduce cost of the support base.

Further, in one or more embodiments, an opening area of the sound hole is larger than opening areas of the penetration holes on the side of the sound hole. By increasing the opening area of the sound hole, it is easy to have at least part of the openings of the penetration holes on the sound hole side overlap the opening of the sound hole on the support base side. Consequently, when the support base is attached to the package, a tolerance for misalignment of the support base is high, so that it is easy to assemble the microphone.

In a microphone according to one or more embodiments of the present invention, the penetration hole is branched in the support base from the side of the sound hole to the side of the acoustic sensor. Accordingly, a position of the sound hole is not restricted by opening positions of the penetration holes on the acoustic sensor side (or positions of cavities of the acoustic sensors). Consequently, the degree of freedom of the positions to provide the sound hole becomes high.

Further, in one or more embodiments, the sound hole and the openings of the penetration holes on the side of the acoustic sensor do not overlap when seen from a direction vertical to an upper surface of the support base. According to this configuration, dust or light hardly enters the acoustic sensors from the sound hole through the penetration holes, so that it is possible to prevent the microphone from deteriorating.

In a microphone according to one or more embodiments of the present invention, part of the sound hole is blocked by the support base. A mode in which the support base blocks part of the sound hole may be a mode in which the support base covers part of the sound hole or buries part of the sound hole. Accordingly, it becomes hard for dust or the like to enter the package from the sound hole. Further, even when large sound hole is opened, it is hard for the strength of the package to be lowered.

In a microphone according to one or more embodiments of the present invention, a gap between the acoustic sensors is blocked by the support base. A mode in which the support base blocks the gap between the acoustic sensors may be a mode in which the support base covers the gap between the acoustic sensors or a mode in which the support base buries the gap between the acoustic sensors. Accordingly, the gap between the acoustic sensors is blocked by the support base, so that it is possible to prevent acoustic vibration entering from the sound hole from leaking to the back chamber through the gap between the acoustic sensors. Consequently, leakage of air makes acoustic characteristic such as low frequency characteristics of the microphone hard to be deteriorated.

In addition, embodiments of the present invention may be obtained by adequately combining the above-described components, and the present invention enables multiple variations obtained by combinations of these components.

### BRIEF DESCRIPTION OF THE DRAWINGS

FIG. 1A is a cross-sectional view illustrating a structure of a conventional general microphone.

FIG. 1B is a cross-sectional view illustrating a microphone in which a sound hole of a package is directly connected to acoustic sensors.

FIG. 2 is a cross-sectional view of a microphone in which one sound hole directly connected to two acoustic sensors is opened in a bottom surface of the package.

FIG. 2 B is a perspective view illustrating an inside of the package of the microphone illustrated in FIG. 2A.

FIG. 3A is a cross-sectional view of the microphone in which two sound holes directly connected to two acoustic sensors are opened in the bottom surface of the package.

FIG. 3B is a perspective view illustrating an inside of the package of the microphone illustrated in FIG. 3A.

FIG. 4 is a perspective view illustrating a microphone of a first embodiment of the present invention when seen from a lower surface side.

FIG. 5A is an X-X line cross-sectional view in FIG. 4.

FIG. 5B is a perspective view illustrating an inside of a package of the microphone illustrated in FIG. 5A.

FIG. 6 is a perspective view illustrating a sound hole of the package and an interposer in the microphone of the first embodiment.

FIG. 7 is a cross-sectional view illustrating the microphone of a modified example of the first embodiment.

FIG. 8A is a perspective view illustrating an inside of a package of a microphone of another modified example of the first embodiment.

FIG. 8B is a perspective view illustrating the sound hole of the package and the interposer in the microphone in FIG. 8A.

FIG. 9A is a cross-sectional view illustrating a microphone of a second embodiment of the present invention.

FIG. 9B is a perspective view illustrating an inside of a package of the microphone illustrated in FIG. 9A.

FIG. 10 is a perspective view illustrating the interposer used in the microphone in FIG. 9A when seen from a lower surface side.

FIG. 11A is a cross-sectional view illustrating a microphone of a modified example of the second embodiment of the present invention.

FIG. 11B is a perspective view illustrating an inside of a package of the microphone illustrated in FIG. 11A.

FIG. 12 is a perspective view illustrating an interposer used in the microphone in FIG. 11A when seen from the lower surface side.

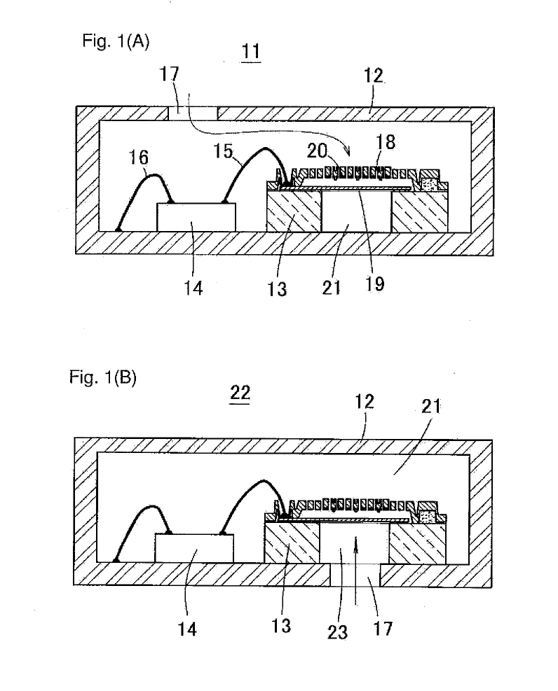

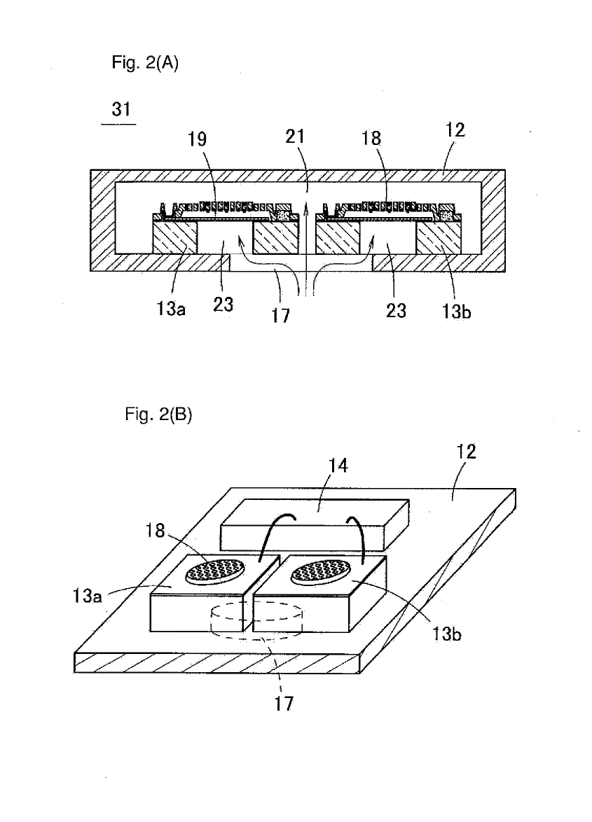

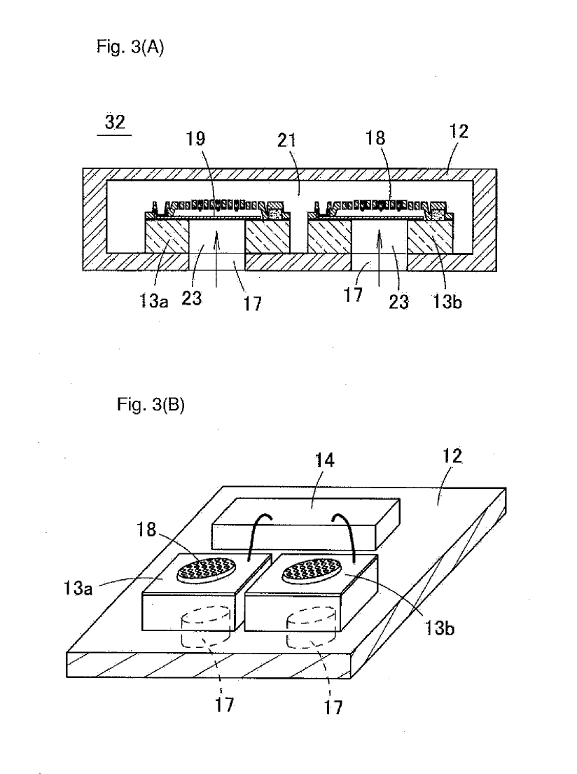

### DETAILED DESCRIPTION

Hereinafter, embodiments of the present invention will be described with reference to the accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. Meanwhile, the present invention is not limited to the following embodiments, and various design changes can be made as long as the changes do not deviate from the spirit of the present invention.

### First Embodiment

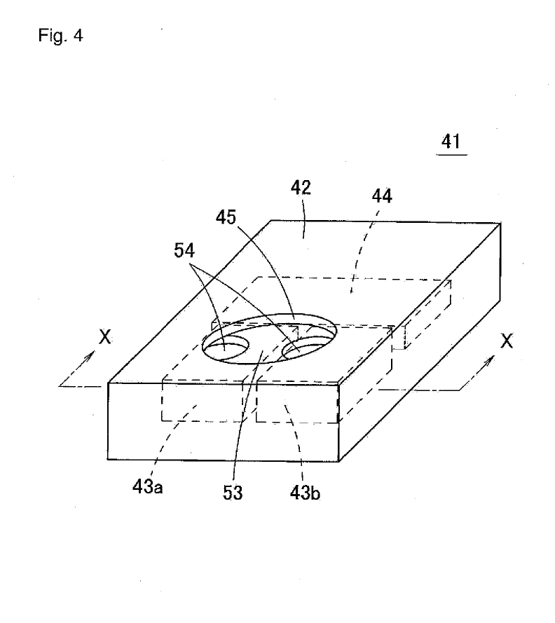

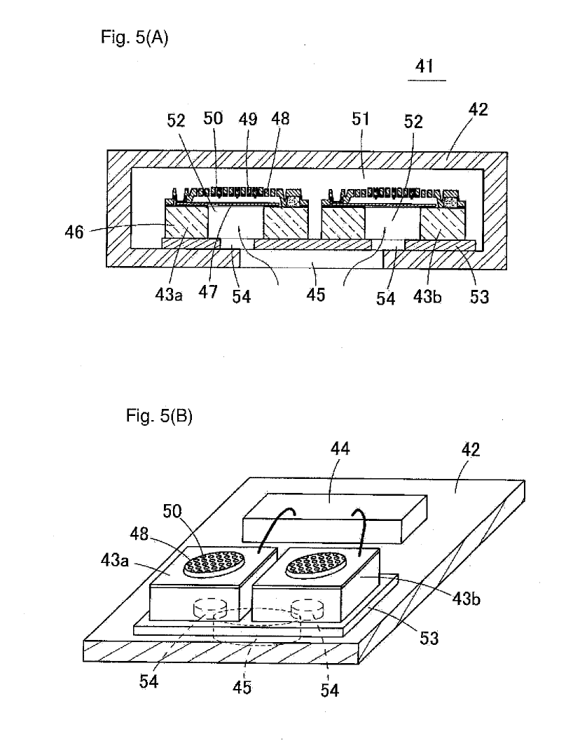

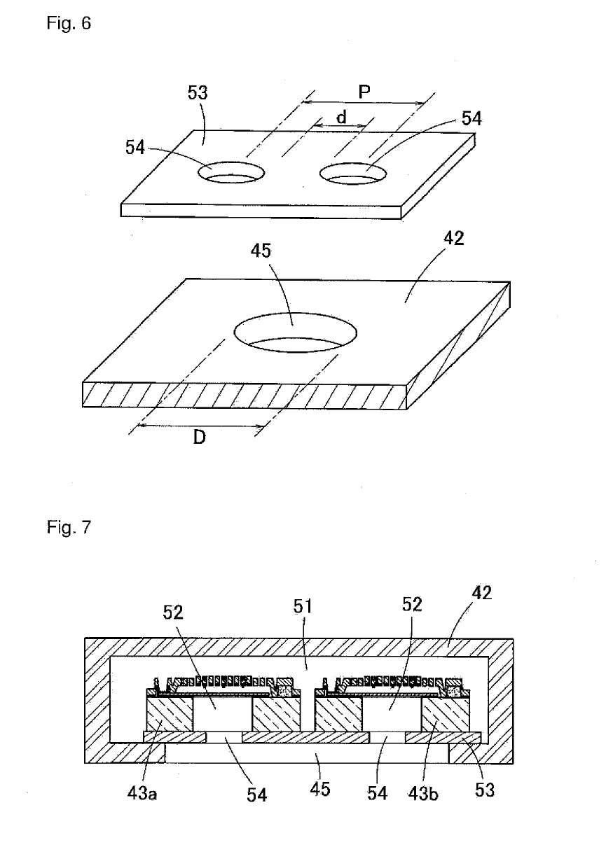

A microphone of the first embodiment of the present invention will be described below with reference to FIGS. 4 to 6. FIG. 4 is a perspective view illustrating a microphone 41 of the first embodiment of the present invention when seen from a lower surface side. FIG. 5A is an X-X line cross-sectional view in FIG. 4, and FIG. 5B is a perspective view illustrating an inside of a package of the microphone 41. FIG. 6 is a perspective view illustrating a sound hole 45 of a package 42 and an interposer 53 (support base).

As illustrated in FIGS. 5A and 5B, in the microphone 41, two acoustic sensors 43a and 43b and a processing circuit 44 such as an ASIC are accommodated in the package 42, and the acoustic sensors 43a and 43b and the processing circuit 44 are connected by bonding wires. The flat interposer 53 is fixed to a bottom surface of the package 42, and the acoustic sensors 43a and 43b are fixed to the upper surface of the interposer 53 and close to each other without contacting each other.

The package 42 is simply illustrated as a hollow integrated article in the drawings, and is actually formed by a wiring substrate and a cover which covers the wiring substrate. One sound hole 45 is opened in the bottom surface of the package 42. The sound hole 45 may have any shape, and may have a circular, elliptical or rectangular shape.

As illustrated in FIG. 6, the interposer 53 has two vertically penetrating penetration holes 54 and 54. The penetration holes 54 and 54 may also have any shapes, and may have circular, elliptical or rectangular shapes. An inter-center distance P between the two penetration holes 54 and 54 is longer than the widths of the acoustic sensors 43a and 43b. Further, a (shortest) distance d between the penetration holes 54 and 54 is shorter than a width D of the sound hole 45, i.e., the diameter of the circle, the long diameter of the ellipse or the side length of the rectangle which is the sound hole 45.

A material of the interposer 53 and a method of making the interposer 53 are not limited in particular. For example, the penetration holes 54 and 54 may be formed using a silicon wafer as a material and using a general MEMS three dimensional process method (such as a D-RIE method or an alkaline etching method). Further, the interposer 53 may be made by resin molding using resin as a material. Alternatively, the penetration holes 54 and 54 may be formed using a printed substrate as a material, and using a typical printed substrate making method and a mechanical hole making method such as drilling or punching. Alternatively, the interposer 53 may be made using a thin metal plate as a material, and using a processing method such as drilling, punching, singulating or polishing.

As illustrated in FIG. 5A, the acoustic sensors 43a and 43b are formed on the upper surfaces of semiconductor substrates 46 such as Si substrates. The semiconductor substrate 46 has a vertically penetrating cavity, and a conductive diaphragm 47 is provided on the upper surface of the semiconductor substrate 46 to cover the upper surface of the cavity. The diaphragm 47 is spaced apart from the upper surface of the semiconductor substrate 46 and is supported by postbox anchors (not illustrated) at portions as appropriate. A protective film 48 made of an insulation material is provided above the diaphragm 47. The protective film 48 covers the diaphragm 47 in a dome shape. Further, an outer periphery portion of the protective film 48 is fixed to the upper surface of the semiconductor substrate 46. The lower surface of the protective film 48 is provided with a conductive fixed electrode film 49 to oppose to the diaphragm 47 with a gap (air gap) provided therebetween. Multiple small vertically penetrating acoustic holes 50 are opened in the protective film 48 and the fixed electrode film 49.

The acoustic sensors 43a and 43b are fixed by adhering the lower surfaces of the acoustic sensors 43a and 43b air-tight to the upper surface of the interposer 53. The acoustic sensors 43a and 43b are adhered using resin or a double-side adhesive tape. In this regard, when seen from a direction vertical to the upper surface of the interposer 53, the acoustic sensor 43a is arranged such that the center of the lower surface opening of the cavity of the acoustic sensor 43a substantially matches the center of one penetration hole 54, and the acoustic sensor 43b is arranged such that the center of the lower surface opening of the cavity of the acoustic sensor 43b substantially matches the center of the other penetration hole 54. As described above, the inter-center distance P between the penetration holes 54 and 54 is longer than the widths of the acoustic sensors 43a and 43b. Consequently, it is possible to space apart the two acoustic sensors 43a and 43b without contacting each other and arrange the two acoustic sensors 43a and 43b on the upper surface of the interposer 53. In addition, the acoustic sensors may not be capacitance type acoustic sensors. Further, the two acoustic sensors 43a and 43b have the same characteristics in some cases and have different characteristics in some cases according to use of the microphone 41.

The interposer 53 on which the two acoustic sensors 43a and 43b are fixed by adhering the lower surface of the interposer 53 air-tight to the bottom surface of the package 42. The interposer 53 is adhered using resin or a double-side adhesive tape. In this regard, as illustrated in FIG. 4, when seen from the direction vertical to the bottom surface of the package 42, the interposer 53 is arranged such that at least part of the penetration holes 54 and 54 of the interposer 53 overlap the sound hole 45 of the package 42, respectively. As described above, the distance d between the penetration holes 54 and 54 is shorter than width D of the sound hole 45, so that it is possible to arrange the interposer 53 such that at least part of the penetration holes 54 and 54 overlap the sound hole 45, respectively.

The processing circuit 44 is formed by an amplification circuit, a power circuit or an output circuit.

Hence, in this microphone 41, acoustic vibration having entered the package 42 from the sound hole 45 is branched into two by the penetration holes 54 and 54 of the interposer 53 as illustrated in FIG. 5A. Then, the acoustic vibration having passed through the penetration holes 54 and 54 vibrates the diaphragms 47 and 47 of the acoustic sensors 43a and 43b. As a result, in each of the acoustic sensors 43a and 43b, the acoustic vibration is converted into a capacitance between the diaphragm 47 and the fixed electrode film 49, and an electrical signal is output to the processing circuit 44.

The sound hole 45 is directly connected to the cavity of each of the acoustic sensors 43a and 43b, so that the cavity of each of the acoustic sensors 43a and 43b is a front chamber 52 and a space in the package 42 (an outside of the acoustic sensors 43a and 43b) is a back chamber 51. Consequently, it is possible to increase the volume of the back chamber 51 in the microphone 41, and improve the sensitivity of the microphone 41 and acoustic characteristics such as frequency characteristics.

Moreover, the two acoustic sensors 43a and 43b are provided, so that the processing circuit 44 can add outputs of the acoustic sensors 43a and 43b and improve the sensitivity, and by switching between the outputs of the acoustic sensors 43a and 43b, increase the sensitivity, a frequency band or a sound pressure band.

Moreover, when the two acoustic sensors 43a and 43b are built in the microphone 41, the acoustic sensor 43a and the acoustic sensor 43b are arranged acoustically independently without contacting each other. Consequently, it is possible to prevent vibrations of the acoustic sensors 43a and 43b from causing an interference or noise.

Further, although the two acoustic sensors 43a and 43b are arranged inside the microphone 41 without contacting each other, a gap between the acoustic sensors 43a and 43b is blocked by the interposer 53. Consequently, the acoustic vibration does not leak from the gap between the acoustic sensors 43a and 43b to the back chamber 51. Further, the surroundings of the cavities (front chambers 52) of the acoustic sensors 43a and 43b are sealed by adhering the lower surfaces of the acoustic sensors 43a and 43b to the upper surface of the interposer 53. Consequently, the acoustic vibration does not leak from a gap between the lower surfaces of the acoustic sensors 43a and 43b and the upper surface of the interposer 53. The lower surface of the interposer 53 is also adhered to the bottom surface of the package 42 to seal surroundings of the penetration holes 54, so that the acoustic vibration does not leak from the gap between the lower surface of the interposer 53 and the bottom surface of the package 42, either. Consequently, the acoustic vibration having entered from the sound hole 45 is less likely to leak to the back chamber 51 and the acoustic characteristics such as low frequency characteristics of the microphone 41 are good.

The microphone 41 of the first embodiment of the present invention adopts the above structure and provides the function and the operation and, as a result, can make compatible both of (1) that the two acoustic sensors are built in the package and (2) that the sound hole is directly connected to the cavity in each acoustic sensor.

Further, part of the sound hole 45 is covered by the interposer 53, so that this microphone 41 is robust against a disturbance entering from the sound hole 45. That is, foreign materials such as dust or a liquid or factors such as compressed air or an excessive sound pressure which causes a damage are less likely to intrude the package 42 from the sound hole 45. Consequently, it is possible to enhance robustness of the acoustic sensors 43a and 43b against the disturbance.

Further, the interposer 53 is adhered to the package 42, so that the rigidity of the package 42 becomes high. Consequently, even when equipment in which the microphone 41 is assembled is dropped and then a shock is applied to the microphone 41, the package 42 is less likely to be deflected or distorted and the microphone 41 is less likely to be damaged by the shock.

Further, when the microphone 41 is assembled, the two acoustic sensors 43a and 43b are fixed to the upper surface of the interposer 53 and then the interposer 53 to which the acoustic sensors 43a and 43b are attached is accommodated in the package 42. According to this procedure, the acoustic sensors 43a and 43b can be attached to the interposer 53 outside the package 42, so that it is possible to simplify the operation of assembling the microphone 41.

### Modified Example 1

FIG. 7 is a cross-sectional view illustrating a microphone of a modified example of the first embodiment of the present invention. In this modified example, an opening area of a sound hole 45 is made larger. Particularly, the opening area of the sound hole 45 is made larger such that penetration holes 54 and 54 of the interposer 53 are both accommodated in the sound hole 45 when seen from a direction vertical to an upper surface of an interposer 53.

In a microphone 41 of the first embodiment, the strength of a package 42 is enhanced by adhering the interposer 53 to the bottom surface of the package 42, so that it is possible to keep the strength of the package 42 even when the opening area of the sound hole 45 is made larger. Further, the interposer 53 is interposed between acoustic sensors 43a and 43b and the package 42, so that it is possible to independently determine the size of each of the acoustic sensors 43a and 43b and the opening area of the sound hole 45. Consequently, it is possible to make the opening area of the sound hole 45 substantially larger. When the sound hole 45 is large, a tolerance for misalignment upon assembly of the interposer 53 and the acoustic sensors 43a and 43b in the package 42 becomes high, so that productivity in an assembly process of the microphone improves.

### Modified Example 2

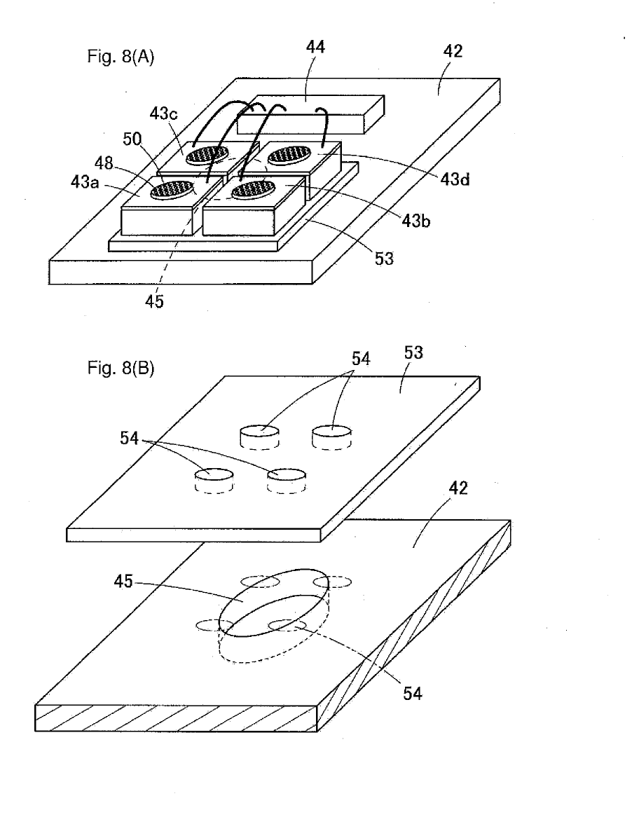

Three or more acoustic sensors may be built in a microphone. FIG. 8A is a perspective view illustrating an inside of a package of a microphone of a modified example of the first embodiment of the present invention. FIG. 8B is a perspective view illustrating a sound hole of the package and an interposer in the microphone in FIG. 8A.

According to this modified example, four acoustic sensors 43a, 43b, 43c and 43d are built in a package 42. In an interposer 53, four penetration holes 54 are opened to meet positions of cavities (front chambers 52) of the acoustic sensors 43a to 43d. Further, a sound hole 45 is opened in the bottom surface of the package 42 such that at least part of the four penetration holes 54 overlap when seen from a direction vertical to the upper surface of the interposer 53.

Even when three or more acoustic sensors are built in, it is possible to possible to provide the same function and operation as those of the microphone 41 by making the other configuration the same as the configuration of the microphone 41 of the first embodiment.

### Second Embodiment

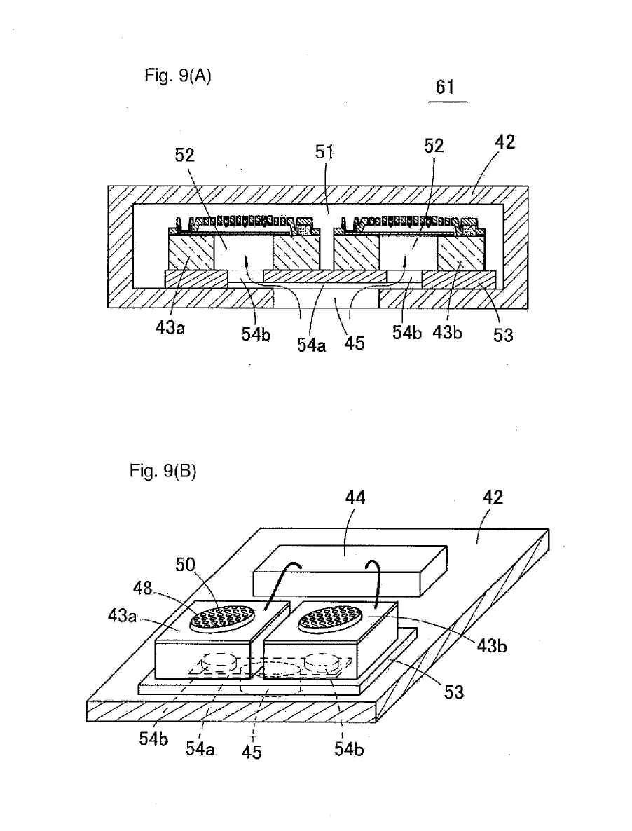

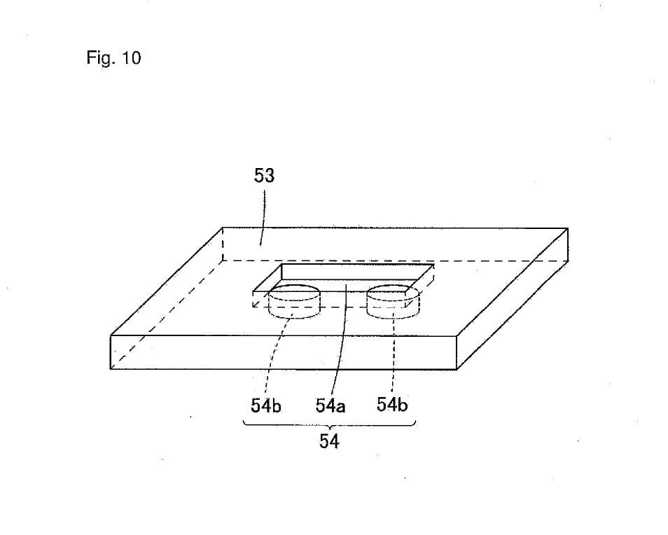

FIG. 9A is a cross-sectional view illustrating a microphone 61 of the second embodiment of the present invention. FIG. 9B is a perspective view illustrating an inside of a package 42 of the microphone 61 illustrated in FIG. 9A. Further, FIG. 10 is a perspective view illustrating an interposer 53 used in the microphone 61 when seen from a lower surface side.

The interposer 53 used in the microphone 61 adopts a two-layer structure as illustrated in FIG. 10. Two vertically penetrating penetration portions 54b are opened in an upper layer and a communication portion 54a is dented in the lower layer to overlap both of the penetration portions 54b. The penetration hole 54 is formed by the communication portion 54a and the two penetration portions 54b. The penetration portion 54b is provided to substantially match a cavity portion of each of acoustic sensors 43a and 43b. A sound hole 45 of the package 42 is opened at a position overlapping a center portion of the communication portion 54a.

In this microphone 61, acoustic vibration having entered the sound hole 45 is transmitted in the communication portion 54a from the sound hole 45, passes through the penetration portion 54b and reaches the inside of the cavity of each of the acoustic sensors 43a and 43b. Consequently, even when a width (D) of the sound hole 45 is shorter than a distance (d) between the penetration holes 54 and the sound hole 45 does not overlap both penetration portions 54b when seen from a direction vertical to the upper surface of the interposer 53, the sound hole 45 is not blocked by the interposer 53 and the penetration holes 54 are not blocked by the package 42. Consequently, according to this structure, it is possible to make the opening area of the sound hole 45 smaller. Further, it is also possible to provide the sound hole 45 such that a front chamber 52 of the acoustic sensor 43a cannot be linearly viewed from the sound hole 45, so that dust or light is less likely to enter the cavities of the acoustic sensors 43a and 43b.

This microphone 61 is the same as that of the first embodiment except the structure of the interposer 53 and the size of the sound hole 45. Hence, although the same function and operation as those of the microphone 41 of the first embodiment are provided, description thereof will be omitted.

In addition, when the interposer 53 is formed by three layers or more, the communication portion 54a may be provided in an intermediate layer. When, for example, the interposer 53 have three layers, the penetration portions 54b may be provided to upper and lower layers and the communication portion 54a may be provided to a center layer.

### Modified Example 3

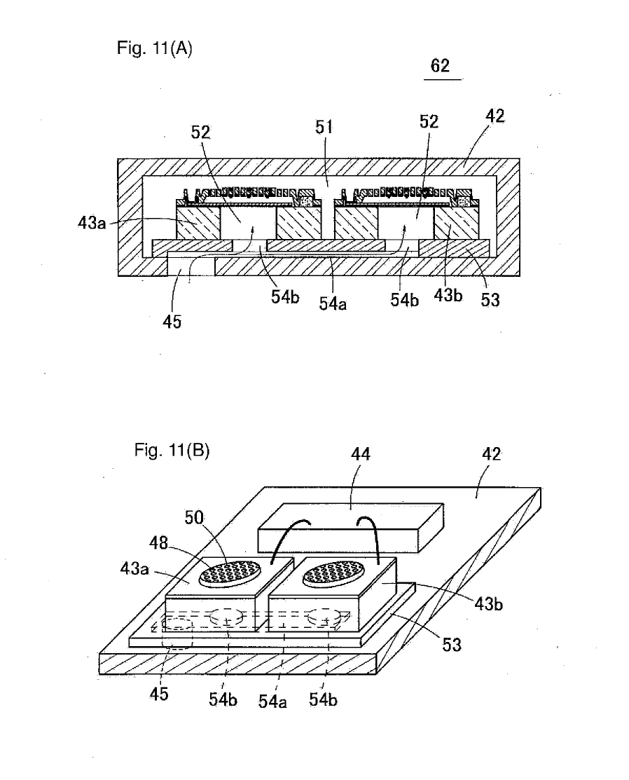

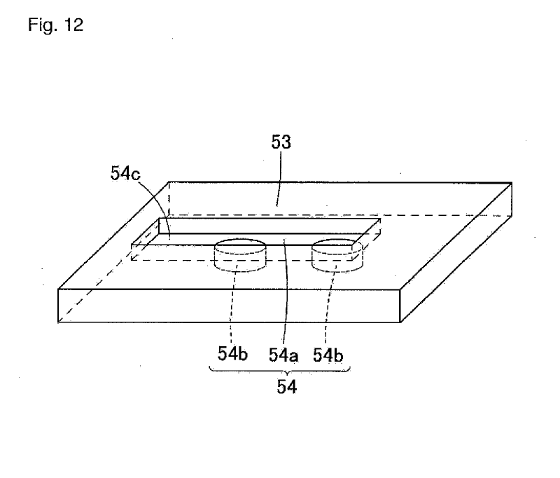

FIG. 11A is a cross-sectional view illustrating a microphone 62 of a modified example of the second embodiment of the present invention. FIG. 11B is a perspective view illustrating an inside of a package 42 of the microphone 62. Further, FIG. 12 is a perspective view illustrating an interposer used in the microphone 62 when seen from a lower surface side.

In the second embodiment of the present invention, a plurality of penetration portions 54b continues to each other through a communication portion 54a. Consequently, when the communication portion 54a is provided in the lower surface of an interposer 53, it is possible to provide a sound hole 45 at an arbitrary position by extending the communication portion 54a in an arbitrary direction. Therefore, the degree of freedom of the position of the sound hole 45 becomes high. When, for example, as illustrated in FIG. 12, the penetration portion 54b is extended to a position apart from the communication portion 54a, it is also possible to provide the sound hole 45 of the package 42, at a position 54c apart from the penetration portion 54b or the cavities of the acoustic sensors 43a and 43b as illustrated in FIGS. 11A and 11B.

In addition, in case of the second embodiment of the present invention, three or more acoustic sensors may be built in the package 42.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

41, 61, 62 MICROPHONE
42 PACKAGE
43a, 43b, 43c, 43d ACOUSTIC SENSOR
45 SOUND HOLE
47 DIAPHRAGM
49 FIXED ELECTRODE FILM
51 BACK CHAMBER
52 FRONT CHAMBER
53 INTERPOSER
54 PENETRATION HOLE
54a COMMUNICATION PORTION
54b PENETRATION PORTION

1. A microphone comprising:
a package;
a support base fixed to an inner surface of the package; and
a plurality of acoustic sensors disposed on a surface of the support base,
wherein the package comprises a sound hole opened in a region in which the support base is disposed,
wherein the support base comprises penetration holes that include a plurality of openings opened in the surface of the support base and that have the sound hole and a cavity in each of the acoustic sensors in communication with each other, and
wherein the openings of the penetration holes in the surface of the support base are spaced apart from each other, and are in communication with the cavity of each of the different acoustic sensors.

2. The microphone according to claim 1,
wherein the support base includes a plurality of independent penetration holes, and
wherein at least part of openings of the penetration holes on a side of the sound hole overlap an opening of the sound hole on a side of the support base.

3. The microphone according to claim 2, wherein an opening area of the sound hole is larger than opening areas of the penetration holes on the side of the sound hole.

4. The microphone according to claim 1, wherein the penetration hole is branched in the support base from the side of the sound hole to the side of the acoustic sensor.

5. The microphone according to claim 4, wherein the sound hole and the openings of the penetration holes on the side of the acoustic sensor do not overlap when seen from a direction vertical to an upper surface of the support base.

6. The microphone according to claim 1, wherein part of the sound hole is blocked by the support base.

7. The microphone according to claim 1, wherein a gap between the acoustic sensors is blocked by the support base.
